(19) United States
(12) Patent Application Publication
(10) Pub. No.: US 2011/0204610 A1
(43) Pub. Date: Aug. 25, 2011

(54) STEERING COLUMN FOR VEHICLE AND STEERING APPARATUS HAVING THE SAME

(75) Inventor: Hyun Bi Kwon, Wonju-si (KR)

(73) Assignee: Mando Corporation

(21) Appl. No.: 13/033,312

(22) Filed: Feb. 23, 2011

(30) Foreign Application Priority Data
Feb. 23, 2010 (KR) 10-2010-0016269

(51) Int. Cl. B62D 1/185

(52) U.S. Cl. 280/775

(57) ABSTRACT

Disclosed is a steering column for a vehicle and a steering apparatus having the same. By the steering column and the steering apparatus, it is possible to prevent load transmitted to the steering column from being concentrated on a part of the steering column, to make the operating force of the control lever be distributed evenly, and to increase the rigidity of the entirety of the steering column while maintaining the supporting force of the outer and inner tubes at the time of tightening and releasing the control lever for the purpose of tilt or telescope operation, whereby the deformation and fracture of the steering column can be prevented when a driver manipulates the steering wheel.

### CROSS-REFERENCE TO RELATED APPLICATION

This application claims priority from and the benefit under 35 U.S.C. §19(a) of Korean Patent Application No. 10-2010-0016269, filed on Feb. 23, 2010, which is hereby incorporated by reference for all purposes as if fully set forth herein.

### BACKGROUND OF THE INVENTION

1. Field of the Invention

The present invention relates to a steering column for a vehicle. More particularly, the present invention relates to a steering column and a steering apparatus having the same, which makes it possible to prevent load transmitted to the steering column from being concentrated on a part of the steering column, to allow the actuating force of a control lever to be uniformly distributed, and to increase the rigidity of the entire steering column while maintaining the force for supporting the inner and outer tubes of the steering column at the time of tightening and releasing the control lever for the purpose of tilt or telescopic operation, whereby the deformation and fracture of the steering column can be prevented when a driver operates the steering wheel.

2. Description of the Prior Art

As generally known in the art, a steering column is a device for enclosing a steering shaft, which transmits torque produced by operating a steering wheel to a rack-and-pinion mechanism, so as to support the rotation of the steering shaft, the steering column coupled to a vehicle body through one or more brackets so as to secure the position of the steering shaft.

Such a steering column may further include a telescope means and/or a tilt means for a driver's convenience, in which the tilt means is provided so as to adjust the anchoring angle of the steering wheel, and the telescope means is formed by telescopically connecting two hollow pipes so that they can be axially extended or retracted, the telescope means allowing the steering shaft and the steering column to be collapsed so as to absorb impact energy.

FIG. 1 is an exploded perspective view showing a part of a conventional steering column for a vehicle.

As shown in FIG. 1, the conventional steering column includes: an outer tube 100 for enclosing a steering shaft 175 for a vehicle; an inner tube 170 inserted into the outer tube; a lower mounting bracket 165 for fastening the inner tube to the vehicle body; an upper mounting bracket 105 mounted on the top of the outer tube 170 and fastened to the vehicle body; a distance bracket 180 integrally fastened to the outer tube 100, and having a long telescope bore 185; a tilt bracket 150 integrally formed with the upper mounting bracket 105, and having a long tilt bore 110; a fixed gear 145 formed on the outer surface of the tilt bracket 140; a movable gear 140 adapted to be engaged with or disengaged from the fixed gear 145; a tilt bolt 130 extending through the tilt bore 110; a cam 135 engaged with the movable gear 140; and a gear spring 142 interposed between the movable gear 140 and the fixed gear 145.

Either the tilt operation or the telescope operation is applied by tightening or releasing the control lever 115, wherein upon tightening the control lever 115, the tilt bracket 150 becomes narrow, thereby applying compression force to the outer tube 100 to such an extent that the outer tube 100 and the inner tube 170 come into tight contact with each other due to the compression force, thereby preventing the tilt or telescope operation, whereas if the control lever 115 is released, the compression force between the outer tube 100 and inner tube 170 disappears so that the tilt or telescope operation can be conducted.

The telescope operation is completed by tightening the control lever 115 after changing the position of the tilt bolt along the telescope bore 185 formed in the distance bracket 180.

The tilt action is completed by tightening the control lever 115 after changing the position of the tilt bolt 130 along the tilt bore 110.

If the control lever 115 is locked, the outer tube 100 and the steering shaft 175 are fixed, but if the control lever 115 is released, the outer tube 100 and the steering shaft 175 can be tilted with reference to a tilt center 160 by the cam 135, or the steering column can be extended or retracted in the axial direction.

However, such a steering column has a problem in that the supporting force for supporting the steering column and the column's own rigidity are poor since load is concentrated on the tilt bracket and the distance bracket which tightens the steering column by being operated by the tilt bolt and the control lever.

In particular, there are problems in that since the connection part between the tilt bracket fastened to the vehicle body and the outer tube is fragile, the steering column's own rigidity may be reduced as compared to the force for supporting the steering column, the steering column may be deformed or fractured by the torsional load occurring when a driver manipulates the steering wheel, and the steering column may be substantially bent in a vehicle collision

### SUMMARY OF THE INVENTION

Accordingly, the present invention has been made to solve the above-mentioned problems occurring in the prior art, and an object of the present invention is to provide a steering column for a vehicle and a steering apparatus having the same, which make it possible to prevent load transmitted to the steering column from being concentrated on a part of the steering column, to allow the operating force of the control lever to be distributed evenly, and to increase the rigidity of the entirety of the steering column while maintaining the supporting force of the outer and inner tubes at the time of tightening or releasing the control lever for the purpose of tilt or telescope operation, whereby the deformation and fracture of the steering column can be prevented when a driver manipulates the steering wheel.

In order to accomplish this object, there is provided a steering column for a vehicle including: a hollow inner tube for enclosing a steering shaft; and a hollow outer tube, into which the inner tube is inserted, the outer tube being provided with telescope guides protruding from the outer circumference of the outer tube to be diametrically opposite to each other, the outer tube being provided with a first slit formed on the outer circumference between the telescope guides, the first slit extending in the longitudinal direction of the steering shaft, and the outer tube being provided with second slits formed on the outer circumference outside the opposite ends of the telescope guides, respectively, the second slits extending in the circumferential direction.

In accordance with another aspect of the present invention, there is provided a steering apparatus for a vehicle having a steering shaft connected with a steering wheel, and a steering column coupled to the steering shaft and assembled to a vehicle body, the steering column including: a hollow inner tube enclosing a steering shaft; and a hollow outer tube, into which the inner tube is inserted, the outer tube being provided with telescope guides protruding from the outer circumference of the outer tube to be diametrically opposite to each other, the outer tube being provided with a first slit formed on the outer circumference between the telescope guides, the first slit extending in the longitudinal direction of the steering shaft, and the outer tube being provided with second slits formed on the outer circumference outside the opposite ends of the telescope guides, respectively, the second slits extending in the circumferential direction.

According to the present invention as described above, it is possible to prevent load transmitted to the steering column from being concentrated on a part of the steering column, to allow the operating force of the control lever to be distributed evenly, and to increase the rigidity of the entirety of the steering column while maintaining the supporting force of the outer and inner tubes at the time of tightening and releasing the control lever for the purpose of tilt or telescope operation, whereby the deformation and fracture of the steering column can be prevented when a driver manipulates the steering wheel.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view showing a part of a conventional steering column for a vehicle;

FIG. 2 is a perspective view showing a part of a steering column for a vehicle in accordance with an embodiment of the present invention;

FIG. 3 is a side view of FIG. 2;

FIG. 4 is a cross-sectional view of the “A” part in FIG. 3; and

FIGS. 5 to 7 are top plan views showing various embodiments of the outer tube of the inventive steering column.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

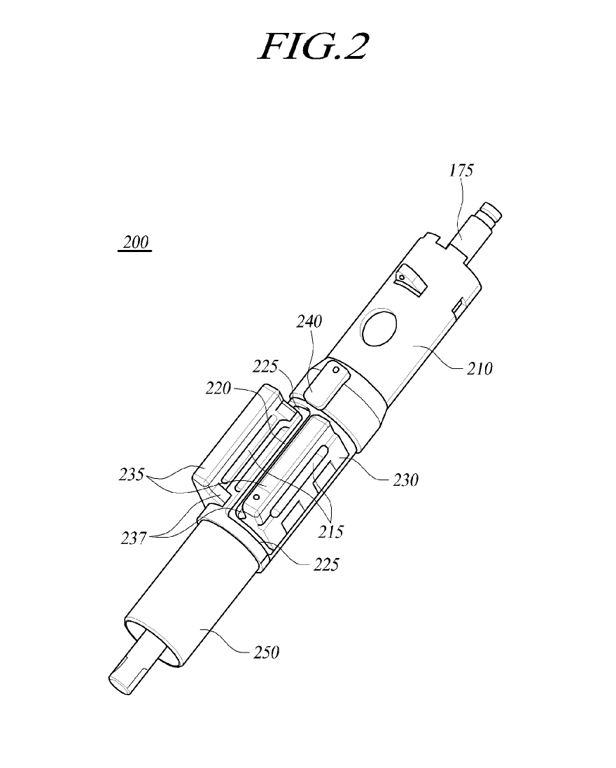

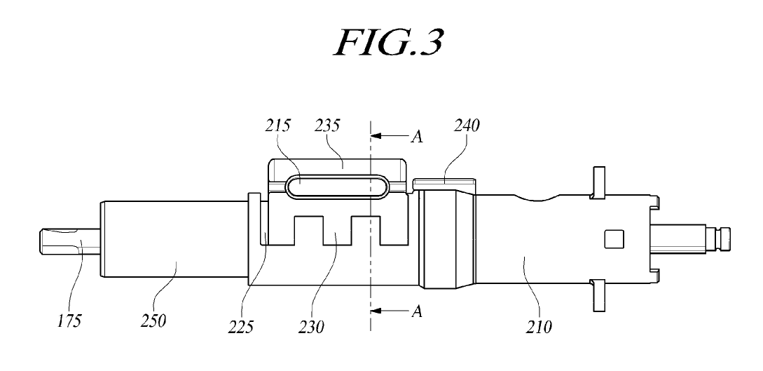

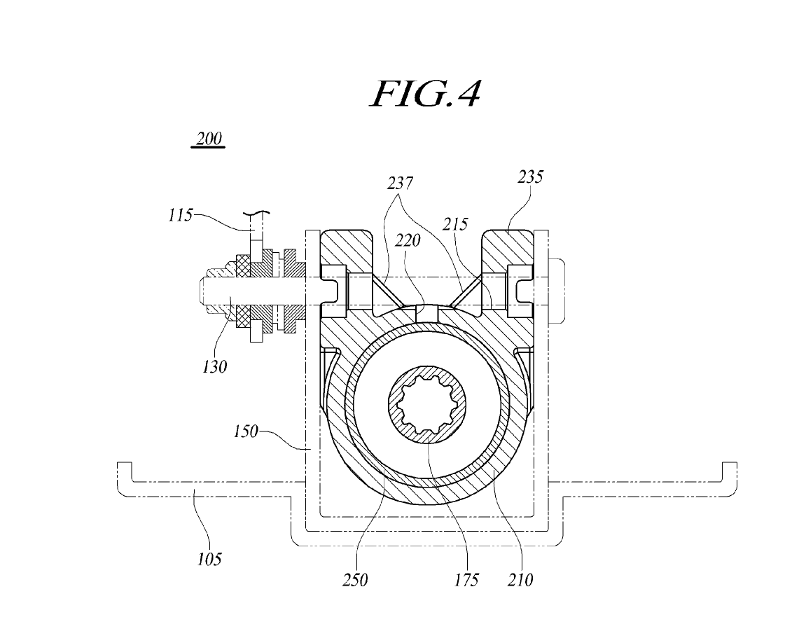

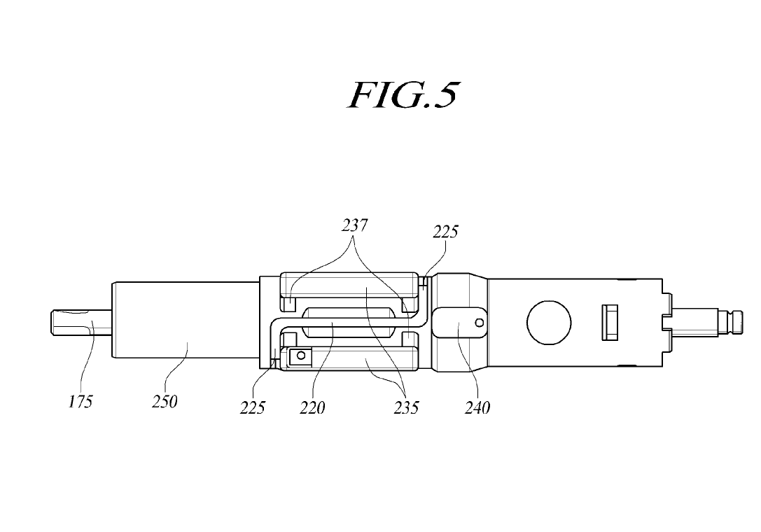

FIG. 2 is a perspective view showing a part of a steering column for a vehicle in accordance with an embodiment of the present invention, FIG. 3 is a side view of FIG. 2, FIG. 4 is a cross-sectional view of the “A.” part in FIG. 3, and FIGS. 5 to 7 are top plan views showing various embodiments for the outer tube of the inventive steering column.

As shown in the accompanying drawings, a steering wheel 200 for a vehicle in accordance with an embodiment of the present invention includes: a hollow inner tube for enclosing a steering shaft 175; and a hollow outer tube 210, into which the inner tube 250 is inserted, the outer tube being provided with a pair of telescope guides 235 protruding from the circumference of the outer tube to be diametrically opposite to each other, the outer tube being provided with a first slit 220 formed on the outer circumference between the telescope guides 235, the first slit extending in the longitudinal direction of the steering shaft 175, and second slits formed on the circumference outside the opposite ends of the telescope guide 235, respectively, the second slits extending in the circumferential direction.

The inventive steering column 200, in which the inner tube 250 is inserted into the outer tube 210, is adapted to conduct tilt or telescope operation in the following manner: upon tightening or releasing a control lever 115 and a tilt bolt 130 coupled to telescope holes 215 in the telescope guides 235, the telescope guides 235 of the outer tube 210 are contracted or slackened diametrically, i.e. perpendicularly to the steering shaft 175, thereby compressing or releasing the inner tube 250, so that the tilt or telescope operation can be conducted.

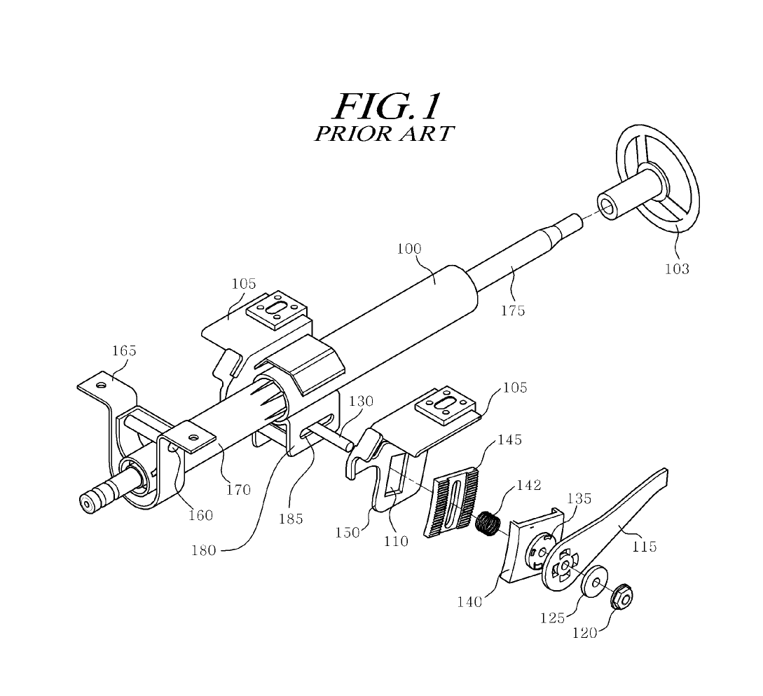

The inner tube 250 has a hollow shape for enclosing the steering shaft 175, and is fastened to the vehicle body through a lower mounting bracket (see the part indicated by reference numeral 165 in FIG. 1), wherein at the time of conducting the tilt operation, the inner tube 250 is rotated about a hinge shaft (see the part indicated by reference numeral 160 in FIG. 1) provided on the lower mounting bracket, and at the time of conducting the telescope operation, the inner tube 250 is adapted to serve as a guide in such a manner that the outer tube 210 can be slid in the longitudinal direction of the steering shaft along the inner tube 250.

The hollow outer tube 210 has a first slit 220 extending in the longitudinal direction of the steering shaft as described above so that the outer tube can be contracted or slackened at the time of conducting the tilt or telescope action, wherein the hollow outer tube 210 is fitted on the inner tube 250 in the longitudinal direction of the steering shaft 175, and the inner tube 250 is fastened to the vehicle body by a lower mounting bracket.

In addition, there are provided telescope guides 235 on the outer circumference of the outer tube 210, wherein the telescope guides 235 are laterally spaced from the first slit 220 in the opposite sides of the first slit 220, so that the telescope guides 235 are oppositely spaced from one another.

That is, in order to narrow the first slit 220, which extends in the longitudinal direction of the steering shaft 175, from the both sides of the first slit 220, the telescope guides 235, each of which has a flange shape with a predetermined thickness, are formed on the outer circumference of the outer tube 210 to be perpendicularly opposed to the steering shaft 174, wherein the telescope guides 235 are provided with telescope holes 215 extending in the longitudinal direction of the steering shaft 175, and a tilt bolt 130 extends through the telescope holes 215 in such a manner that the outer tube 210 is allowed to be slid at the time of telescope operation.

That is, for the purpose of tilt or telescope operation, a driver may release the control lever 115, set the steering column to be suitable for the driver, and then tighten the control lever 115, in which case in order to make it easy to contract the outer tube 210 so that the outer tube 210 can compress the inner tube 250, there are provided telescope guides 235 on the outer circumference of the outer tube 210 which protrude from the outer circumference and to be diametrically opposite to each other.

The telescope guides 235 are coupled to the tilt bracket 150, and restrained by the tilt bracket 250, the tilt bolt 130 extending through the telescope holes 215, and the control lever 115 in such a manner that when the control lever 115 is manipulated, the telescope guides 235 are contracted or slackened, thereby enabling the tilt or telescope operation.

In addition, each of the telescope guides 235 is provided with a reinforcement rib 237 at its protruding area, so that the rigidity of the telescope guides 235 can be reinforced, wherein the reinforcement ribs 247 are abutted against the outer circumference of the outer tube 210.

Meanwhile, since supporting parts 230, through which the telescope guides 235 are engaged with the outer circumference of the outer tube 210, are formed to be spaced from one another in the longitudinal direction of the steering shaft 175, the torsional load occurring at the steering column when a driver operates the steering wheel can be distributed evenly, whereby rigidity can be increased over the entirety of the steering column.

That is, since the telescope guides 235 of the outer tube 210 are fastened to the vehicle body through the tilt bracket 150 and the upper mounting bracket 105, torsional load concentrically occurs at the supporting parts 230 where the outer tube 210 is connected with the telescope guides 235, but the supporting parts 230 formed to be spaced from each other allow torsional load to be more evenly distributed and absorbed along the outer circumference of the outer tube 210 as compared to a case in which the supporting parts 230 are formed integrally without being spaced from each other.

In addition, since the first slit 220 is formed on the outer circumference of the outer tube between the telescope guides 235, the outer tube 210 is adapted to be contracted or slackened at the time of tilt or telescope operation.

As described above, there are provided second slits 225 on the outer circumference outside the opposite ends of the telescope guides 235, respectively, and the second slits 225 extend in the circumferential direction, whereby the second slits 225 can prevent torsional load from being concentrated on a part of the steering column when the torsional load is transmitted to the steering column 200, and the second slits 225 allow operating force to be distributed evenly when the operating force is applied to the control lever for the purpose of tilt or telescope operation.

By providing the second slits 225 in this manner, it is possible to prevent transmitted load from being concentrated on a part of the steering column 200, and it makes it easy for the outer tube 210 to compress the inner tube 250 by narrowing the first slit 220 when the control lever 115 is tightened.

The second slits 225 can be variously embodied as shown in FIGS. 5 to 7.

That is, as shown in FIG. 5, the second slit 225 provided at one end of the telescope guides 235 is formed to extend from one end of the first slit 220 to one side in the circumferential direction, and the second slit 225 provided at the other end of the telescope guides 235 is formed to extend from the other end of the first slit 220 to the other side in the circumferential direction.

That is, the second slits 225 provided at the opposite ends of the first slit 220 extend oppositely from one another in the circumferential direction, wherein the first slit 220 and the second slits 225 may be formed to be communicated with each other.

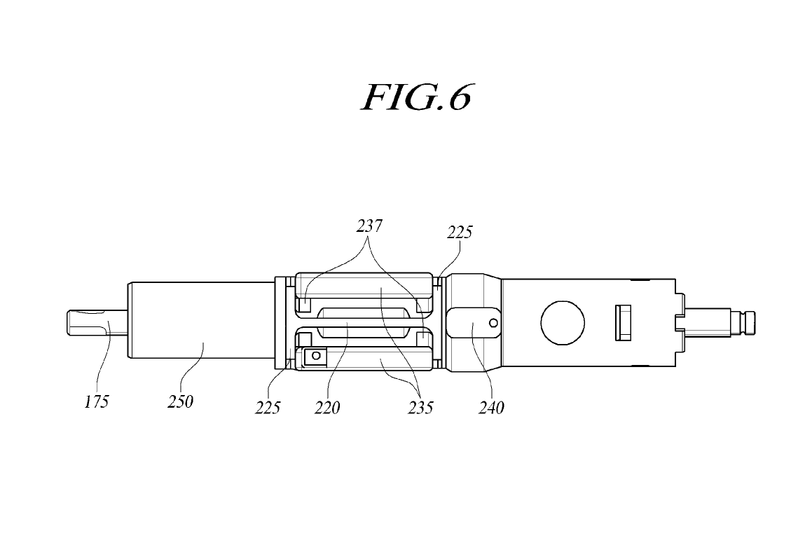

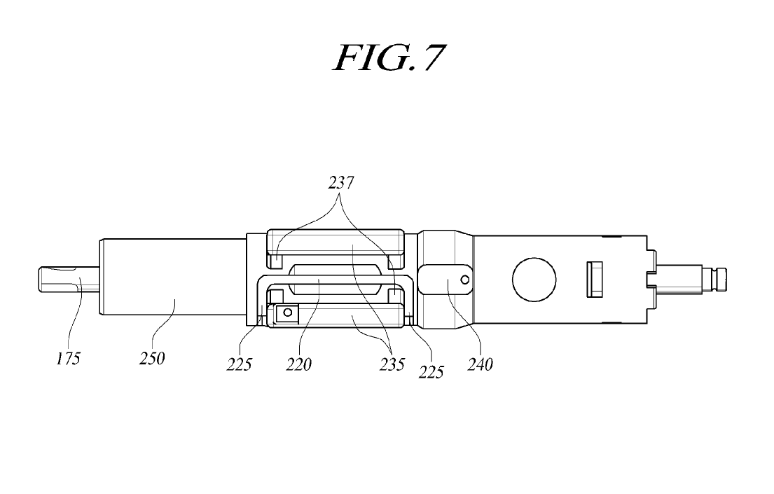

In addition, the second slits 225 may be formed to extend from the opposite ends of the first slit 220 to both sides in the circumferential direction as shown in FIG. 6, or to one side in the circumferential direction as shown in FIG. 7, wherein the first and second slits may be formed to be communicated with each other.

The second slits 225 variously embodied as described above prevent the load transmitted to the steering column 200 from being concentrated on a part of the steering column 200, allow the operating force of the control lever 115 to be distributed evenly, and make it easy for the outer tube 210 to compress the inner tube 250 by narrowing the first slit 220 when the control lever 115 is tightened.

In addition, since a boss 240 radially protruding from the outer circumference is provided outside an end of a second slit 225 opposite to the inner tube insertion end of the outer tube 210, it is possible to prevent the outer tube 210 from being fractured or deformed by torsional load occurring at the steering column when the steering wheel is operated.

In accordance with an aspect of the present invention, there is provided a steering apparatus including a steering column 200 as described above, and a steering shaft 175 connected to a steering wheel 103, the steering column 200 being coupled to the steering shaft as shown in FIG. 1.

Since the steering column 200 of the inventive steering apparatus is fully described above, a detailed description thereof will be omitted.

According to the inventive steering column for a vehicle and a steering apparatus having the same, it is possible to prevent load transmitted to the steering column from being concentrated on a part of the steering column, to allow the operating force of the control lever to be distributed evenly, and to increase the rigidity of the entirety of the steering column while maintaining the supporting force of the outer and inner tubes at the time of tightening or releasing the control lever for the purpose of tilt or telescope operation, whereby the deformation and fracture of the steering column can be prevented when a driver manipulates the steering wheel.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated within the scope of the purpose of the present invention.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although several preferred embodiments of the present invention have been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiments. The scope of the present invention shall be construed on the basis of the accompanying claims in such a manner that all of the technical ideas included within the scope equivalent to the claims belong to the present invention.

What is claimed is:

1. A steering column for a vehicle, comprising:
a hollow inner tube for enclosing a steering shaft; and
a hollow outer tube, into which the inner tube is inserted, the outer tube being provided with telescope guides protruding from the outer circumference of the outer tube to be diametrically opposite to each other, the outer tube being provided with a first slit formed on the outer circumference between the telescope guides, the first slit extending in the longitudinal direction of the steering shaft, and the outer tube being provided with second slits formed on the outer circumference outside the opposite ends of the telescope guides, respectively, the second slits extending in the circumferential direction.

2. The steering column as claimed in claim 1, wherein the second slit provided at one end of the telescope guides extends from one end of the first slit to one side in the circumferential direction, and the second slit provided at the other end of the telescope guides extends from the other end of the first slit to the other side in the circumferential direction.

3. The steering column as claimed in claim 1, wherein the second slits extend from the opposite ends of the first slit in both sides in the circumferential direction, respectively.

4. The steering column as claimed in claim 1, wherein the second slits extend from the opposite ends of the first slit to one side in the circumferential direction.

5. The steering column as claimed in claim 1, wherein each of the telescope guides is provided a reinforcement rib at its protrusion area, the rib being abutted against the outer circumference of the outer tube.

6. The steering column as claimed in claim 1, wherein the first slit and the second slits are communicated with each other.

7. A steering apparatus for a vehicle having a steering shaft connected with a steering wheel, and a steering column coupled to the steering shaft and assembled to a vehicle body, the steering column comprising:
a hollow inner tube enclosing a steering shaft; and a hollow outer tube, into which the inner tube is inserted, the outer tube being provided with telescope guides protruding from the outer circumference of the outer tube to be diametrically opposite to each other, the outer tube being provided with a first slit formed on the outer circumference between the telescope guides, the first slit extending in the longitudinal direction of the steering shaft, and the outer tube being provided with second slits formed on the outer circumference outside the opposite ends of the telescope guides, respectively, the second slits extending in the circumferential direction.

8. The steering apparatus as claimed in claim 7, wherein the second slit provided at one end of the telescope guides extends from one end of the first slit to one side in the circumferential direction, and the second slit provided at the other end of the telescope guides extends from the other end of the first slit to the other side in the circumferential direction.

9. The steering apparatus as claimed in claim 7, wherein the second slits extend from the opposite ends of the first slit in both sides in the circumferential direction, respectively.

10. The steering apparatus as claimed in claim 7, wherein the second slits extend from the opposite ends of the first slit to one side in the circumferential direction.

11. The steering apparatus as claimed in claim 7, wherein each of the telescope guides is provided a reinforcement rib at its protrusion area, the rib being abutted against the outer circumference of the outer tube.

12. The steering apparatus as claimed in claim 7, wherein the first slit and the second slits are communicated with each other.
